(19) United States
(12) Patent Application Publication
(10) Pub. No.: US 2009/0052704 A1
(43) Pub. Date: Feb. 26, 2009

(54) Method of side definition when adjusting hearing aids

(75) Inventor: Herve Schulz, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Instruments Pte. Ltd.

(21) Appl. No.: 12/228,633

(22) Filed: Aug. 14, 2008

(30) Foreign Application Priority Data
Aug. 21, 2007 (DE) 10 2007 039 447.2

(51) Int. Cl. H04R 25/00

(52) U.S. Cl. 381/312

(57) ABSTRACT

The data sets to be stored in the two hearing devices of a binaural hearing system during the adjustment are generally different. During “side definition”, the correct assignment of the two hearing devices to the ears and of the wearer is ensured. To this end, the wearer generates a signal on one of the two hearing devices, which is identified by the adjustment device and is evaluated for side definition purposes.

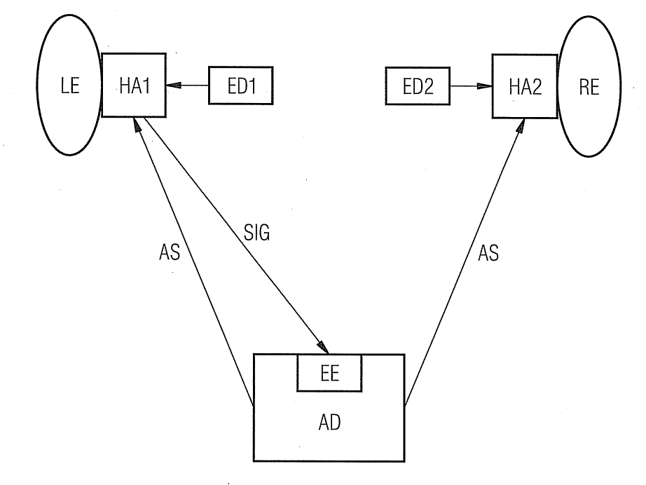

### CROSS REFERENCE TO RELATED APPLICATIONS

This application claims priority of German application No. 10 2007 039 447.2 DE filed Aug. 21, 2007, which is incorporated by reference herein in its entirety.

### FIELD OF INVENTION

The present invention relates to an adjustment of hearings, more particularly to a method of side definition when adjusting hearing aids.

### BACKGROUND OF INVENTION

In many cases, a hearing aid with two hearing devices (two-ear hearing aid, so-called binaural supply) is required or expedient for the adequate supply of a patient with a hearing impairment. In this way, digitally programmable hearing systems are nowadays used almost exclusively, in other words hearing systems, the electroacoustic properties of which can and must be set (“adjusted”) externally by way of a computer. The main advantage of (digitally) programmable hearing systems is that it is possible to set a plurality of electroacoustic parameters in order to compensate more precisely for the hearing loss. The signal processing can be analog (digitally programmable analog hearing systems) or digital (fully digital hearing systems) in the case of these hearing devices. Fully digital hearing devices are hearing systems which convert the analog microphone signal into a digital signal. The digital signal is then processed according to the commands of the programmed software (algorithm) and the switching circuits integrated on the chip. The digital signals are finally converted back into analog signals and forwarded to the receiver. The incoming signal is measured here at certain time intervals (signal scanning). The more frequently the signal is scanned, the better the reproduction of the input signal. The digitization allows significantly more-complex analyses and filterings in respect of an optimum speech/interference noise ratio than was possible with analog systems.

Adjustment devices are used (generally by hearing device acousticians) for the so-called adjustment of hearing devices, in other words to set their parameters (e.g. filter coefficients) or for programming purposes, said adjustment devices regularly being configured as special computers that run a special application software and exchange data with the hearing devices during the adjustment by way of cables or also wirelessly. With the adjustment of binaural (including both ears) hearing aids, a correct assignment of the two hearing devices (HA1, HA2) to the ears (RE) and (LE) of the wearer must take place prior to the adjustment because otherwise the data would be incorrectly assigned to the devices during the adjustment. This assignment of the two hearing devices (HA1, HA2) to the ears (RE) and (LE) of the wearer for the purposes of adjustment is also referred to by the person skilled as the art as side definition.

### SUMMARY OF INVENTION

Side definition does not present a problem if the adjustment device is connected to the hearing device or the hearing devices by way of a cable, because a clear assignment of the ear sides (right or left) to the data is easily possible with the aid of the cable. However if the data is transmitted wirelessly between the adjustment device and the hearing device, a side definition is less simple.

The object underlying the invention is to enable technically simple side definition. This object is achieved by a method or a product as claimed in one of the claims.

### BRIEF DESCRIPTION OF THE DRAWINGS

The invention is described in more detail below with reference to preferred exemplary embodiments and with the aid of the FIGURE.

The sole FIGURE shows a schematic representation of the interaction of an inventive adjustment device (AD) with the hearing devices (HA1, HA2) of a hearing aid (HA) during the implementation of an inventive method according to an advantageous embodiment of the invention.

### DETAILED DESCRIPTION OF INVENTION

A hearing device (HA1, HA2) of the hearing aid (HA) to be adjusted is located here on the left (LE) and on the right (RE) ear in each instance and the adjustment device (AD) exchanges data with at least one of these two hearing devices (e.g. filter coefficients or similar data). The adjustment is ultimately carried out here by suitable data (adjusted to the individual requirements and conditions of the respective ear) being stored in a storage facility of the hearing device, as a result of which a functionality of the hearing device which is adjusted to these individual requirements and conditions is effected.

As each of the two ears generally requires an individual adjustment, the data sets to be stored in the two hearing devices are generally different. It is thus essential to the success of the adjustment process for the data to be stored on the correct hearing device in each instance. This is ensured by the side definition, i.e. by the correct assignment of the two hearing devices (HA1, HA2) to the ears (RE) and (LE) of the wearer.

According to the present invention, the wearer of the hearing devices is requested for that purpose to generate a signal (Sig) on one of the two hearing devices, which is identified by the adjustment device and is evaluated for side definition purposes.

According to a preferred exemplary embodiment of the invention, provision is made for the wearer to generate the signal (Sig) by touching one of the two hearing devices.

The invention can be implemented particularly advantageously if the wearer generates the signal (Sig) by touching a sensor (ED1, ED2), which is located on one of the two hearing devices, or if the wearer generates the signal (Sig) by touching a button or actuating a control element (ED1, ED2), which is located on one of the two hearing devices.

Another advantageous embodiment of the invention provides for the wearer to generate the signal (Sig) by moving a magnet closer to the telephone coil (ED1, ED2) or another magnetic sensor (ED1, ED2) of one of the two hearing devices.

All embodiments of the invention have in common that a device (AD) is regularly provided for adjusting a hearing aid (HA) consisting of two hearing devices (HA1, HA2) for the right (RE) and left (LE) ear, said hearing aid (HA) exchanging data with at least one of the two hearing devices, with this adjustment device (AD) having a facility (EE), which identifies a signal (Sig) generated by the wearer of the hearing devices on one of the two hearing devices and evaluates it for side definition purposes.

It may be advantageous depending on the application situation to transmit an acoustic signal (AS) to the wearer via the receiver of at least one of these hearing devices, whereupon this wearer generates a signal (Sig) on one of the two hearing devices, which the adjustment device (AD) identifies and evaluates for side definition purposes, by said adjustment device determining the hearing device upon which this signal (Sig) was generated by the wearer.

The acoustic signal (AS) may be a speech signal for instance, by means of which the wearer is requested to implement the operation needed for the side definition process. According to another embodiment variant of the invention, the acoustic signal may also contain such a speech signal.

The facility (ED1), by means of the actuation of which the wearer of the hearing aid generates the signal (Sig) required for side definition purposes, is preferably located in and/or on at least one of the two hearing devices. This facility is preferably a switch or corresponding button which is already located on the hearing device, which is used in other contexts, e.g. to change over the hearing program or an operating state of the hearing device and which is used in conjunction with the adjustment method as an input facility for side definition purposes. The effects of actuating this facility can be changed by way of the software of the adjustment device for instance.

Instead of activating a switch or suchlike, the wearer of the hearing device can however also touch a sensor (ED), which is located on one of the two hearing devices. This sensor need not necessarily be dedicated to this purpose, but can instead for instance also be an existing metal contact, e.g. a metallic connecting socket or such like, the capacitance of which changes when touched, which is measured by a facility present in the hearing device and is evaluated accordingly in the phase of the adjustment and/or side definition and transmitted to the adjustment device.

The signal (Sig) to be generated by the wearer of the hearing devices can also be generated by tapping one of the microphones (ED1, ED2) of the hearing devices or by a different type of sound generation in the vicinity of such a microphone. Here the directional characteristics of several microphones or one directional microphone can also be used by an asymmetrical sound generation in respect of these microphones.

Another option consists in using a so-called wireless system, in which the hearing devices are positioned in a programming shell for instance and with the customer or the hearing device acoustician performing the side definition by means of side programming.

Depending on the type of signal (Sig) used for side definition purposes, it is potentially necessary or expedient to inform the wearer of the hearing aid of the action he/she is to take to deliver or implement the communication. The action can be agreed here advantageously such that the wearer of the hearing aid is also informed by way of the speech signal of the action by means of which he/she is to deliver or implement the communication. In the said example, the speech signal may thus contain the text “Please touch the sensor on your right hearing device” or suchlike.

1.-8. (canceled)

9. A method for adjusting a hearing aid including a hearing device for a right ear and hearing device for a left ear, comprising:
receiving a signal generated from one of the two devices via a wearer of the hearing aid, the signal for the correct assignment of the two hearing devices to the ears and of the wearer of these hearing devices;
evaluating the signal for a side definition; and
exchanging data with at least one of the two hearing devices.

10. The method as claimed in claim 9, wherein the wearer generates the signal by touching one of the two hearing devices.

11. The method as claimed in claim 9, wherein the wearer generates the signal by touching a sensor that is located on at least one of the two hearing devices.

12. The method as claimed in claim 9, wherein the wearer generates the signal by touching a button that is located on at least one of the two hearing devices.

13. The method as claimed in claim 9, wherein the wearer generates the signal by touching an actuating a control element that is located on at least one of the two hearing devices.

14. The method as claimed in claim 9, wherein the wearer generates the signal by moving a magnet closer to the telephone coil of one of the two hearing devices.

15. The method as claimed in claim 9, wherein the wearer generates the signal by moving a magnet closer a magnet sensor of one of the two hearing devices.

16. The method as claimed in claim 9, wherein the wearer generates the signal by tapping a microphone of one of the two hearing devices, or by another type of sound generation in the vicinity of such a microphone.

17. The method as claimed in claim 9, wherein the wearer generates the signal by asymmetrical sound generation on a directional microphone of the two hearing devices.

18. A device for adjusting a hearing aid consisting of a hearing device for the right and a hearing device for the left ear, comprising;
a facility that receives a signal generated by one of the two hearing devices via a wearer of the hearing devices, the facility evaluates the received signal for side definition purposes; and
a facility that receives a signal generated by the wearer of the hearing devices on one of the two hearing devices and evaluates the received signal for side definition purposes,
wherein the device exchanges data with at least on of the two hearing devices.
